(19) United States
(12) Patent Application Publication
(10) Pub. No.: US 2001/0054153 A1
(43) Pub. Date: Dec. 20, 2001

(54) System and method for determining user identity fraud using similarity searching

(76) Inventors: David B. Wheeler, Austin, TX (US); John R. Ripley, Round Rock, TX (US); Paul Leury, Cedar Park, TX (US)

Correspondence Address: TAYLOR RUSSELL & RUSSELL, PC, 4807 SPICEWOOD SPRINGS ROAD, BUILDING ONE, SUITE 1200, AUSTIN, TX, 78745

(21) Appl. No.: 09/681,532

(22) Filed: Apr. 24, 2001

Related U.S. Application Data
(60) Provisional application No. 60/201,074, filed on Apr. 26, 2000.

(51) Int. Cl. H04L 9/00

(52) U.S. Cl. 713/185

(57) ABSTRACT

A method for verifying the identities of new users of a computer system, using batch similarity searching. The method comprises receiving a plurality of records, each record containing profile data input by a new user; similarity searching the profile data of each record against suspended-users profile data; determining, for each record, whether a positive match or a negative match exists between the profile data of the record and the suspended-users profile data; allowing a new user to access the computer system, where a negative match is determined between the record of the new user and the suspended-users profile data; and forwarding the record of a new user to a review process, where a positive match is determined between the record of the new user and the suspended-users profile data.

### CROSS REFERENCE TO RELATED APPLICATIONS

Referenced-applications

This application claims the benefit of U.S. Provisional Application 60/201074, filed Apr. 26, 2000.

### BACKGROUND OF THE INVENTION

The current invention relates to identifying occurrences of User Identity Fraud. More specifically, the invention relates to identifying User Identity Fraud by batch profile searching for similarities across databases and determining the validity of identity attributes submitted by new users that are attempting to gain access to computer systems.

A user or potential user of a computer system commits User Identity Fraud, when the user attempts to gain access to the computer system by knowingly misrepresenting their identifying attributes. Due to past activities, users may be prohibited from accessing information on certain computer systems. These users may attempt to circumvent such restrictions by altering their identity information when attempting to establish new accounts. Consequently, operators of computer systems have been in need of a means to identify these users, by searching across multiple databases for commonalities or similarities in the identity attributes provided by a user when creating a new account. Hence, a system and method have been developed to verify the identities of users who are attempting to establish new accounts, by performing batch similarity searching for new user identity attributes, across multiple databases. By employing the current invention, operators can better understand who is actually granted access to their computer systems.

### SUMMARY OF INVENTION

The present invention is directed to a method for verifying the identities of new users of a computer system, using batch similarity searching. The method comprises the steps of receiving a plurality of records, each record containing profile data input by a new user and similarity searching the profile data of each record against suspended-users profile data. The step of receiving records may also comprise creating an account for each new user. The method also includes receiving a similarity search result set and determining, for each record, whether a positive match or a negative match exists between the profile data of the record and the suspended-users profile data. The step of determining a positive or negative match further comprises assigning a match score to each similarity search result set; and comparing the match score to a pre-determined match tolerance level.

The method also includes allowing a new user to access the computer system, where a negative match is determined between the record of the new user and the suspended-users profile data. Where a positive match is determined, the method allows for forwarding the record of a new user to a review process. The review process comprises confirming whether the positive match exists between the profile data of the record and the suspended-users profile data, allowing the new user to access the computer system, where the positive match is not confirmed, and permanently or temporarily denying the new user access to the computer system, where the positive match is confirmed.

One embodiment of the method comprises receiving a plurality of records into a production new-user database and updating a new-users profile database, with profile data from each record received into the production new-users database. A suspended-users profile database, which contains suspended-user profile data, is then updated with additional suspended-user profile data stored in a production-suspended-users database. The new-user profile data is relayed from the new-user profile database to a batch similarity search engine and the new-user profile data is similarity searched against the suspended-users profile database, via the batch similarity search engine. At least one similarity search result set is received, and it is determined, for each record, whether a positive match or a negative match exists between the profile data of the record and the suspended-users profile data. A new user is allowed to access the computer system, where a negative match is determined between the record of the new user and the suspended-users profile data. The record of a new user is forwarded to a review process, where a positive match is determined between the record of the new user and the suspended-users profile data. The review process comprises forwarding the record to a review database and displaying the database via a web-based interface. It is confirmed whether the positive match exists between the profile data of the record and the suspended-users profile data. The new user is allowed to access the computer system, where the positive match is not confirmed, and the new user is denied access to the computer system, and the profile data of the new user's record is forwarded to the production suspended-users database, where the positive match is confirmed.

The current invention is also directed toward a software program, embodied on computer-readable media, incorporating the invented method.

The current invention is also directed toward a system for verifying identities of new users of a computer system, using batch similarity searching. The system comprises means for receiving records from a plurality of new users; means for extracting new-user profile data from each record; means for similarity searching the new-user profile data against suspended-users profile data; means for receiving similarity search results sets; means for determining whether a positive match or a negative match exists between the new-user profile data of each record and the suspended-users profile data; means for allowing a new user to access the computer system, where a negative match exists; and means for reviewing the record of a new user, where a positive match exists between the record and suspended-users profile data, comprising means for confirming whether the positive match exists between the record and suspended-users profile data; means for allowing the new user to access the computer system, where the positive match is not confirmed; and means for denying the new user access to the computer system, where the positive match is confirmed.

Batch profile searching involves searching one database against another in order to determine similarities between the two databases. Searching for similarities between databases involves similarity search technology, cross database search technology, result triggering technology, and result set storage technology. For instance, batch SSE Profile Searching can search data from one database against another in order to find XML document similarities between the two databases. When a similarity match is made within a specified tolerance between two databases, a specified action or event can take place. For example, if a strong similarity match is made from a fraudulent users database against a new users database, a notification can be forwarded to an investigator for further notice. The Batch SSE Profile Search methodology allows users to compare vast amounts of data using specific business practices and intrinsic analytical logic so that the contents of a database can be better understood.

The similarity search technique used in the present invention may be any similarity search technique that yields a similarity search result. For example, it may be the similarity search technique described in U.S. Pat. No. 5,666,442 by Wheeler issued Sep. 9, 1997. It may also use the similarity search technique described in U.S. patent application Ser. No. 09/401,101 by Wheeler et. al, filed on Sep. 22, 1999, which is incorporated by reference herein. Other similarity search techniques may be utilized.

### BRIEF DESCRIPTION OF DRAWINGS

FIG. 1 is a diagram showing elements and steps of a system for identifying user identity fraud using batch similarity profile searching.

FIG. 2 is a flow diagram illustrating steps of a method for identifying user identity fraud using batch similarity profile searching.

FIG. 3 a diagram showing elements of a database to database search logic architecture, in accordance with the present invention.

FIG. 4 is a diagram illustrating elements of a web-based interface, in accordance with the present invention.

FIG. 5 is a flow diagram illustrating steps of a new user review workflow, in accordance with the present invention.

FIG. 6 is a diagram illustrating elements of a web-based user interface display architecture, in accordance with the present invention.

### DETAILED DESCRIPTION

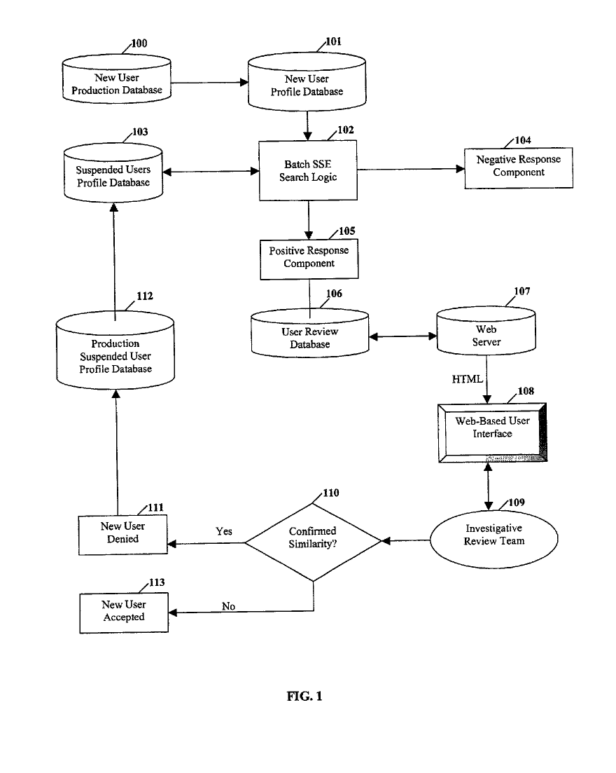

Referring now to the drawings, the present invention is directed to a system and method for identifying user identity fraud, using batch profile similarity searching. FIG. 1 shows elements of a system for identifying user identity fraud, in accordance with the present invention. A Production New User Database 100 is used to store profile data about each new user who attempts to establish an account on the system. A New User Profile Database 101 is updated with the targeted profile data from the New User Production Database 100. After a period of updates, which may be set by the system operator, a batch search is performed. The profile data in the New User Profile Database 101 is similarity searched against a Suspended Users Profile Database 103, using a Batch Similarity Search Engine (SSE) 102, which contains database-to-database search logic. The Suspended Users Profile Database 103 contains other users that have been removed or suspended from the system in the past. The Suspended Users Profile Database 103 is periodically updated from the Production Suspended Users Profile Database 112.

Similarity searching of new user records is performed against a number of hierarchical, context sensitive, identity attributes contained in the Suspended Users Profile Database 103. When the search is completed, a similarity search result set is returned to the Batch SSE 102. If a new user identity record does not have a similarity match within a specified tolerance level, the new user is forwarded to a Negative Response Component 104. The tolerance level may be set by a system operator. The Negative Response Component 104 is responsible for actions taken when a similarity profile match does not meet the specified tolerance level. These actions may include validating the new user account and accepting the new user into the system.

If the new user identity record has a similarity match within the tolerance level, the new user is forwarded to the Positive Response Component 105. The Positive Response Component 105 adds the search result set to a User Review Database 106.

Once the batch similarity search has been performed, an Investigative Review Team 109 accesses the User Review Database 106, in order to take actions against users that match those contained in the Suspended Users Profile Database 103. The Investigative Review Team 109 accesses the User Review Database 106 through a Web-Based User Interface 108. The Web-Based User Interface 108 may communicate with the User Review Database 106 via a Java Database Connectivity (JDBC) connection. The Web-Based User Interface 108 is provided by a number of different screens, or pages, that are formatted by a Web Server 107. The pages may use Java Server Pages (JSP), Java Servlets, Extensible Markup Language (XML), Extensible Stylesheet Language (XSL), and Hypertext Markup Language (HTML). Once the User Interface Pages are formatted and filled with data from the User Review Database 106, HTML is used to transmit the pages from the Web Server 107 to one or more members of the Investigative Review Team 109, via the Web-Based User Interface 108.

Using the Web-Based User Interface 108, the Investigative User Review Team 109 confirms whether each new user identity record that has a similarity match to an existing user contained in the Suspended Users Profile Database 103. This confirmation is represented in FIG. 1 at 110. When reviewing a new user identity record, the team determines if the new user is trying to gain access to the system by creating a new, fictitious account. If the new account is sufficiently similar to an existing account contained in the Suspended Users Profile Database 103, the Investigative User Review Team 109 makes a decision to suspend the new user account. This decision is represented in FIG. 1 at 111. The suspension may be permanent, or it may last only for a certain period—for example, 30 days. If the new user identity record is similar to an existing suspended user account, within the match tolerance used by the Batch SSE 102, but does not appear to actually be the same account, the Investigative User Review Team 109 makes a decision to grant the user access to the system. This decision in represented in FIG. 1 at 111. The Investigative User Review Team 109 may reserve action until another time, in this case.

Once a user has been suspended, the new user identity record is added into the Production Suspended Users Profile Database 112. The updates to the suspended users production database are included in the next periodic import into the Suspended User Profile Database 103.

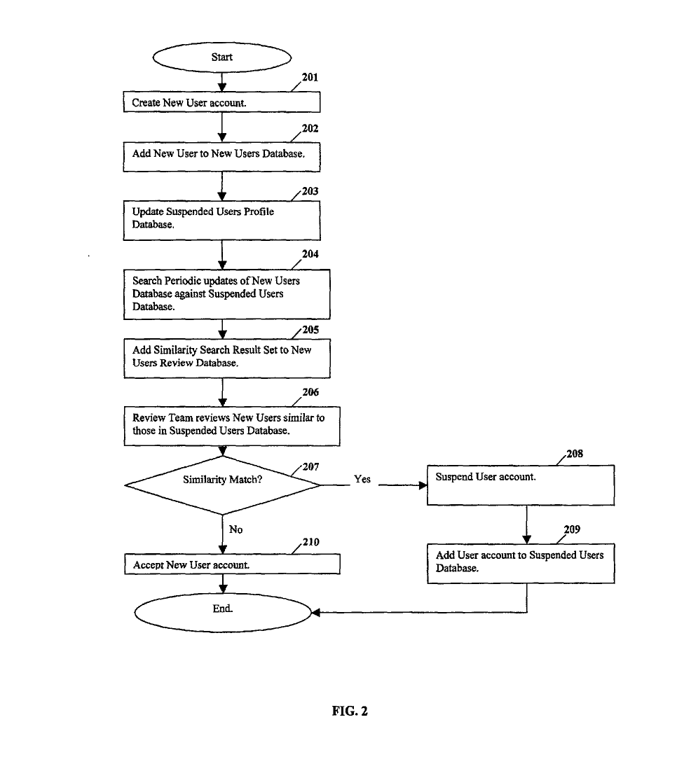

FIG. 2 illustrates steps of a method for identifying user identity fraud, in accordance with the present invention. In accordance with step 201, a new user account is created, for example on an E-commerce web site. In accordance with step 202, the new user account is added to a New Users Profile Database. The new user may be temporarily granted access to the site until the account has been reviewed. In accordance with step 203, a Suspended Users Profile Database is updated. Once the Suspended Users Profile Database has been updated, a batch search will be performed on each new user in the last periodic update to the New Users Profile Database, in accordance with step 204. The identity record of each new user is similarity searched against every suspended user in the Suspended Users Profile Database. When the similarity search has completed, a similarity search result set is then added to the New Users Review Database, in accordance with step 205.

In accordance with step 206, the New Users Review Database is analyzed by a review team, via a web-based interface. Where similarity between a new user identity record and one or more suspended user profiles has been determined during the similarity search, the review team reviews the new user identity record to determine if the new user should be granted or denied access to the system. In accordance with step 207, the review team determines whether a similarity match indeed exists between the new user identity record and the suspended user profiles. If the new user is in fact similar to the suspended user, the user account is then suspended, in accordance with step 208. The new user is then added to the suspended users database, in accordance with step 209. If the new user account is not actually similar to a user in the suspended user database, the user review team accepts the new user, in accordance with step 210.

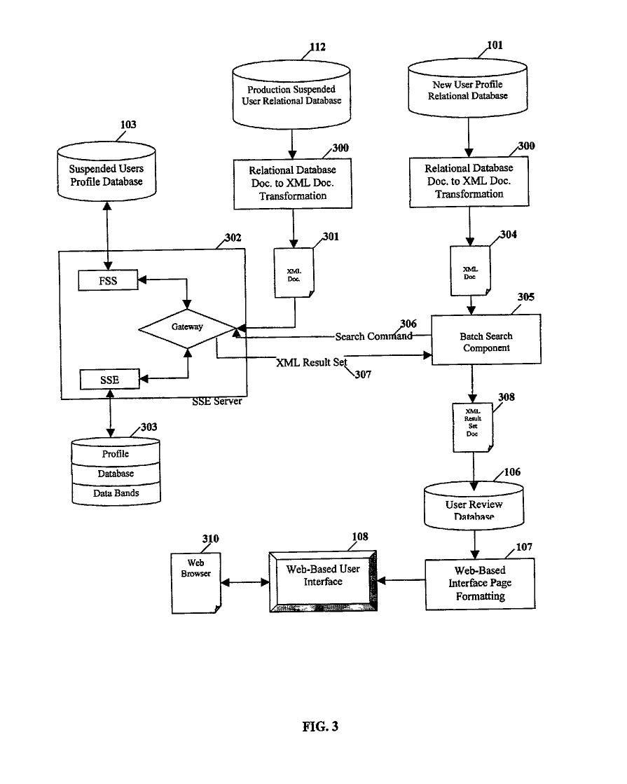

FIG. 3 illustrates an architecture for one embodiment of a system for identifying user identity fraud, in accordance with the present invention. The system architecture for identifying user identity fraud involves updating two production databases and searching one against the other, in order to find similarities between records in the two databases. Results are then stored in a third user review database that is accessed by user review officials through a web-based interface.

A Production Suspended Users Relational Database, as described at 112 in FIG. 1, is periodically imported into a Suspended Users Profile Database, described at 103 in FIG. 1, before a batch search is performed. Within this process, a record is read from a relational database and transformed into a XML Document 301 using a data transformation process 300. The data transformation process 300 may include any process suitable for transforming a relational database document into a XML document.

The XML Document 301 is then saved on the SSE Server 302 for hierarchical database storage and indexing. Within this storage process, a document write command is received within the SSE Server 302 by a Gateway component. The XML Document 301 is then indexed and stored by the Similarity Search Engine (SSE) and File Storage System (FSS) components, respectively. The FSS component saves the XML Document 301 into the Suspended Users Profile Database 103. The SSE component hierarchically indexes the XML Document 301 within Profile Database Data Bands 303.

In another phase of the system architecture, a New User Profile Database, as described at 101 in FIG. 1, is periodically searched against the Suspended User Profile Database 103. A relational database record is read from the New User Profile Database 103. The record is then transformed into an XML Document 304 using data transformation process 300. The document is then fed to a Batch Search Component 305, where a similarity search command 306 is formulated and sent to the SSE Server 302. Within the SSE Server 302, the XML Document 304 from the new user relational database is searched against the Suspended Users Profile Database Data Bands 303 by the SSE. The SSE returns a search result set that is packaged using XML. The XML Result Set 307 is then passed back to the Batch Search Component 305. The XML result set 307 is then transmitted as a XML Result Set Document 308 to a User Review Database, as described at 106 in FIG. 1, where it is stored. Within the User Review Database 106, the XML Result Set document 308 may be stored, for example, as a binary large object (BLOB) field.

Once data has been batch searched from one database to another, data in the results database can be reviewed through a Web-Based User Interface, as described at 108 in FIG. 1. The web based interface extracts data from the User Review Database 106, across a Web-Based Interface Page Formatting component, described at 107 in FIG. 1. This may be accomplished, for example, using a Java Database Connectivity (JDBC) connection. Java Server Pages (JSP), Extensible Markup Language (XML), Extensible Stylesheet Language (XSL), and java Servlets access and format data stored in the results database through the JDBC connection. The information may then be transmitted in HTML format to the Web-Based User Interface 108, where it can be viewed by accessing the Web-Based User Interface 108 through a web browser 310.

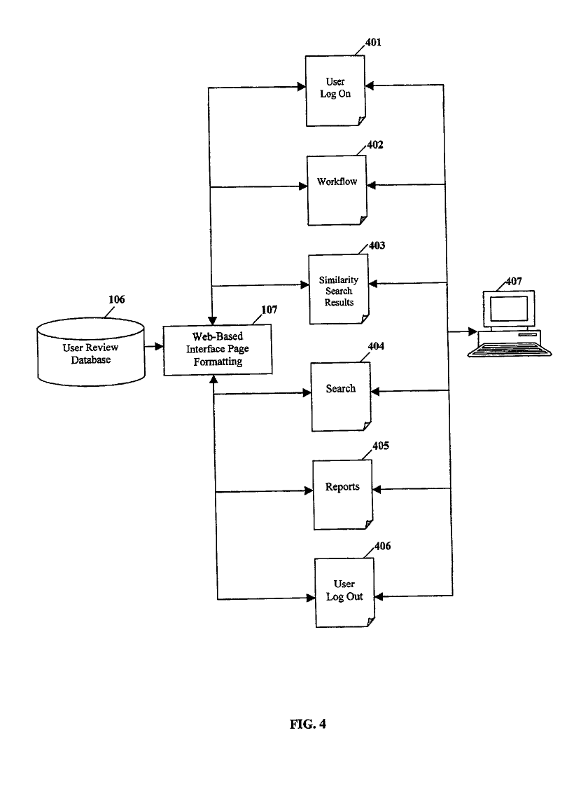

FIG. 4 illustrates the Web-Based User Interface that provides the mechanism, by which User Review Team members can use a computing device 407 to interact with the User Review Database 106. The User Review Database 106 stores the similarity search result sets that were returned from searching the New User Profile Database against the Suspended User Profile Database. The XML documents stored in the User Review Database 106 are reviewed via a Web-Based User Interface, to allow Review Team members to determine if similarities actually exist between new user records and suspended user profiles.

A number of interfaces 401-406 are provided with the Web-Based User Interface. These interfaces may interact with the User Review Database 106 though a JDBC connection. A Web-Based Interface page Formatting component 107 formats the various interfaces and transforms them to HTML format, so they can be viewed using a web browser operating on the computing device 407.

There are a number of different main screens that provide core functionality for the new user review process. The first screen that is encountered when using the Web-Based User Interface is the User Log On screen 401. The User Log On screen 401 allows the investigative review official to login to the Web-Based User Interface. Once a user is granted access to the Web-Based User Interface, a session may be established between a web client operating on the computing device 407 and a web server on which the Web-Based User Interface is operating.

When the login is complete, the user review official is presented with a Workflow screen 402. The Workflow screen 402 is used to complete the main function of the system, to access new user records, and to analyze the validity of new users. When presented with the Workflow screen 402, the user review official may select for review a new user, or block of new users, that has had a similarity profile match within the Suspended Users Profile Database. The user review official can then select a user and analyze them further through interacting with the Similarity Search Results screen 403.

The Similarity Search Results screen 403 displays the details of the new user and which profiles they have a similarity match to in the Suspended User Profile Database. From the Similarity Search Results screen 403, a user can drill into the details for the similarity match on the new user account or each suspended user account. The user may also view any new or suspended user accounts side-by-side so that similarities between the selected accounts can be better viewed. Once a new account has been reviewed, an action can be taken to suspend, or grant access for the new user account.

The Search screen 404 allows the user review official to locate certain user data in the system for further review and investigation. When the search criteria is submitted to the production database, the user has the ability to order the results to be returned by any field in the search criteria. What is returned is a list of suspended users in the production database that match the search criteria. Users can then further inspect the list of search results as needed.

The Reports screen 405 allows users to view the overall status of the user review workflow process. The user has the option of displaying a report for a given date. A report may comprise, for example, a list of similarity score ranges with the number of new user profile search results that matched in the given range, and a comparison of the number of matching new and suspended users with a total number of the new and suspended users. The report may also comprise review activity statistics for given dates. The statistics may comprise, for example, information about each user's individual reviews and the number of users suspended or granted access by a user, along with the number of hours that a user worked on reviewing a block of new users.

The Log Out screen 406 is the last screen that a user visits before exiting the Web-Based User Interface. When selecting the Log Out screen, users may be automatically logged off the Web-Based User Interface, or they may be given an option to logoff the Web-Based User Interface. The Log In screen 401 may be automatically displayed after the user logs off the Web-Based User Interface.

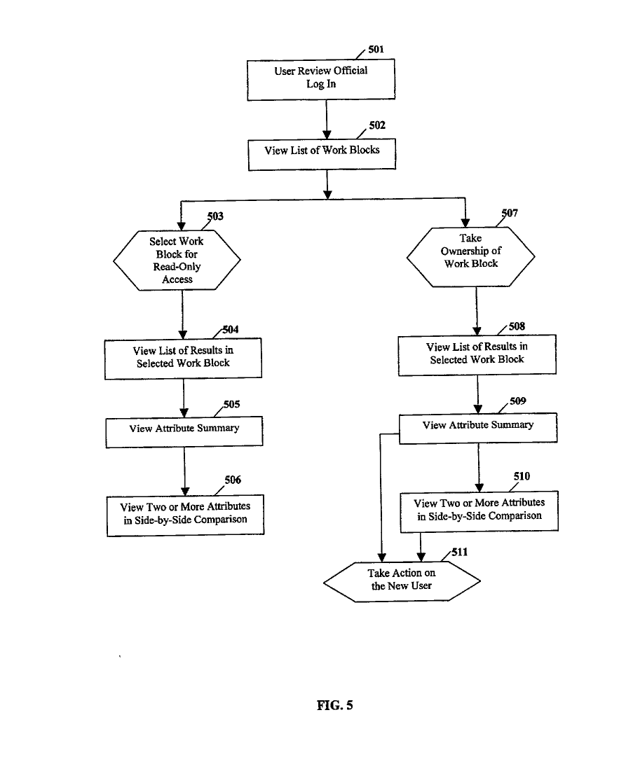

FIG. 5 illustrates steps of one embodiment of a method for interacting with the Web-Based User Interface to identify the validity of a new user that has been given access to the system, in accordance with the present invention. In accordance with step 501, a review team member logs onto the Web-Based User Interface. Once granted entry into the system, the review team member views a list of work blocks, in accordance with step 502. Each work block contains a number of similarity search result sets corresponding to new users whose records matched suspended user profiles, within set match tolerances. The work blocks may also contain statistics, review status indicators, and ownership indicators that identify whether another review team member is already reviewing the particularly similarity search result set. Depending on the ownership status, the review team member can then either view a selected block on a read-only basis, in accordance with step 503, or take ownership of the selected block, in accordance with step 507.

If the review team member decides to view the block in read-only mode, per step 503, then the user is presented with the details of the selected block, but no ability to take action regarding the new users contained in the block. In accordance with step 504, the review team member views similarity search result sets contained in the work block. From the selected block details screen the user review official can then select a particular user and view the details of the similarity search result set from the suspended users profile database. In addition to search results, the similarity search result set may also contain the similarity high score compared to the profile database, the new user ID, any actions that have been taken already, the name of the investigator that has taken the action, and the time that the action was taken.

In accordance with step 505, the review team member views an attribute summary screen, which allows the user review official to view the new user identity attributes along with the comparisons contained in the similarity search result set. To aid this process, the review team member may choose to view two or more identities side-by-side, in accordance with step 506, so that they can more easily identify the similarities between the various new user attributes. From either the view attribute or the side-by-side comparison screens, the user review official has the ability to take an action on the user, given they do not have read-only access.

If the user takes ownership of a work block, per step 507 then the block is locked against other team members taking ownership, a time stamp of when ownership was taken is added to the block, and the review team member is presented with the details of the selected block and the ability to take action regarding the new users contained in the block. In accordance with step 508, the review team member views similarity search result sets contained in the work block. From the selected block details screen the user review official can then select a particular user and view the details of the similarity search result set from the suspended users profile database. In addition to search results, the similarity search result set may also contain the similarity high score compared to the profile database, the new user ID, any actions that have been taken already, the name of the investigator that has taken the action, and the time that the action was taken.

In accordance with step 509, the review team member views an attribute summary screen, which allows the user review official to view the new user identity attributes along with the comparisons contained in the similarity search result set. To aid this process, the review team member may choose to view two or more identities side-by-side, in accordance with step 510, so that they can more easily identify the similarities between the various new user attributes. From either the view attribute or the side-by-side comparison screens, the user review official may take an action regarding the new user, in accordance with step 511. The specified action might be, but is not limited to, a full suspension, limited suspension, no action, or reinstate user.

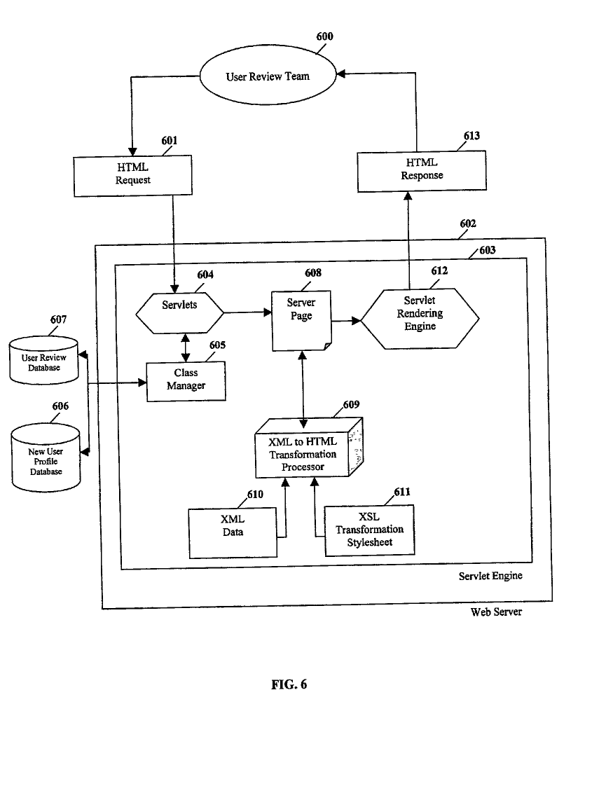

FIG. 6 illustrates elements of an embodiment of the Web-Based User Interface Architecture, in accordance with the present invention. The Web-Based User Interface Architecture contains three interacting areas: the web client user, the web server, and content databases. The User Review Team 600 interacts with the Web-Based User Interface, in order to review new users who have been found by a SSE to match profiles in a Suspended Users Database, within match tolerances, as described with reference to FIG. 1.

The User Review Team 600 may request a web page by issuing a HTML request 601 to a Web Server 602, by selecting a hyperlink in a web browser, for example. A new page request 601 may be intercepted by a Java Servlet Engine 603, which begins the process of turning a web page request into a web page response. The Java Servlet Engine 603 may host a number of different individual servlets 604. These servlets 604 may act as functional “applications” which take a request, perform their individual function, and return a response in the form of a server page 608. To assist the Java Servlets, there is a Class Manager, which provides the common functionalities used by all the servlets 604, in rendering their Java server pages 608, such as interacting with the User Review Database 607 and the New User Profile Database 607.

Once the Java Servlets have performed their functions, a Java Server Page (JSP) 608 is created and forwarded on for further processing. If the Java Server Page contains XML and XSL, the page is then forwarded onto the XML to HTML Transformation Processor 609 for further processing. The XML to HTML Transformation Processor 609 may comprise a XSLTProcessor bean. Using the XML data contained in the Java Server Page 608, the XML Data component 610 of the XML to HTML Transformation Processor 609 prepares the XML data to be rendered by XSL specifications. 755 Using the XML data 610 and XSL specifications, the XSL Transformation Stylesheet 677 is used to render the XML data into HTML.

Once a request has been turned into a java Server Page 608, the Server Page 608 is sent through the Servlet Rendering Engine 612 . The Servlet Rendering Engine 612 is responsible for the final packaging of a HTML page and for sending of the HTML response 613 back to the web client used by the User Review Team 600. The Servlet Rendering Engine 612 may comprise another Java Servlet that performs the function of final HTML preparation, and web response dispatch. The output from the Servlet Rendering Engine 612 is the HTML response 613. The HTML response 613 is the page that is sent back to the client web browser that sent the initial HTML request 601 . When received by the web client browser that sent the HTML request 601, the new page is then displayed to the User Review Team 600.

The current invention is also directed to a software program embodied on computer-readable media, incorporating the method of the current invention.

Using the foregoing, the invention may be implemented using standard programming or engineering techniques including computer programming software, firmware, hardware or any combination or subset thereof. Any such resulting program, having a computer readable program code means, may be embodied or provided within one or more computer readable or usable media, thereby making a computer program product, i.e. an article of manufacture, according to the invention. The computer readable media may be, for instance a fixed (hard) drive, disk, diskette, optical disk, magnetic tape, semiconductor memory such as read-only memory (ROM), or any transmitting/receiving medium such as the Internet or other communication network or link. The article of manufacture containing the computer programming code may be made and/or used by executing the code directly from one medium, by copying the code from one medium to another medium, or by transmitting the code over a network.

An apparatus for making, using or selling the invention may be one or more processing systems including, but not limited to, a central processing unit (CPU), memory, storage devices, communication links, communication devices, server, I/O devices, or any sub-components or individual parts of one or more processing systems, including software, firmware, hardware or any combination or subset thereof, which embody the invention as set forth in the claims.

User input may be received from the keyboard, mouse, pen, voice, touch screen, or any other means by which a human can input data to a computer, including through other programs such as application programs.

Although the present invention has been described in detail with reference to certain embodiments, it should be apparent that modifications and adaptations to those embodiments may occur to persons skilled in the art without departing from the spirit and scope of the present invention as set forth in the following claims.

1. A method for verifying the identities of new users of a computer system, using batch similarity searching, comprising:
a. receiving a plurality of records, each record containing profile data input by a new user;
b. similarity searching the profile data of each record against suspended-users profile data;
c. receiving a similarity search result set;
d. determining, for each record, whether a positive match or a negative match exists between the profile data of the record and the suspended-users profile data;
e. allowing a new user to access the computer system, where a negative match is determined between the record of the new user and the suspended-users profile data; and
f. forwarding the record of a new user to a review process, where a positive match is determined between the record of the new user and the suspended-users profile data, the review process comprising:
i. confirming whether the positive match exists between the profile data of the record and the suspended-users profile data;
ii. allowing the new user to access the computer system, where the positive match is not confirmed; and
iii. denying the new user access to the computer system, where the positive match is confirmed.

2. The method of claim 1, wherein the step of determining a positive or negative match further comprises
assigning a match score to each similarity search result set; and
comparing the match score to a pre-determined match tolerance level.

3. The method of claim 1, wherein the step of denying a new user access to the computer system comprises permanently denying the new user access to the computer system.

4. The method of claim 1, wherein the step of denying a new user access to the computer system comprises temporarily denying the new user access to the computer system for a pre-determined period.

5. The method of claim 1, wherein the step of receiving a plurality of records further comprises creating an account for each new user.

6. The method of claim 1, wherein the step of receiving a plurality of records further comprises receiving a plurality of records into a production new-user database.

7. The method of claim 6, further comprising updating a new-users profile database, with profile data from each new-user record received into the production new-users database, before the step of similarity searching.

8. The method of claim 7, further comprising updating a suspended-users profile database, containing suspended-user profile data, with additional suspended-user profile data stored in a production-suspended-users database, before the step of similarity searching.

9. The method of claim 8, wherein the step of similarity searching further comprises similarity searching the new-user profile data against the suspended-users profile database, via a batch similarity search engine.

10. The method of claim 1, wherein the positive response process further comprises relaying the new-user record to a user-review database, before the step of confirming at least one similarity.

11. The method of claim 10, further comprising the step of displaying the user-review database via a web-based interface, after the step of relaying the new-user record to a user-review database and before the step of confirming at least one similarity.

12. A software program, embodied on computer-readable media, incorporating the method of claim 1.

13. A method for verifying identities of new users of a computer system, using batch similarity searching, comprising:
a. receiving a plurality of records into a production new-user database, each record comprising profile data input by a new user;
b. updating a new-users profile database, with profile data from each record received into the production new-users database;
c. updating a suspended-users profile database, containing suspended-user profile data, with additional suspended-user profile data stored in a production-suspended-users database;
d. relaying the new-user profile data from the new-user profile database to a batch similarity search engine;
e. similarity searching the new-user profile data against the suspended-users profile database, via the batch similarity search engine;
f. receiving at least one similarity search result set;
g. determining, for each record, whether a positive match or a negative match exists between the profile data of the record and the suspended-users profile data;
h. allowing a new user to access the computer system, where a negative match is determined between the record of the new user and the suspended-users profile data; and
i. forwarding the record of a new user to a review process, where a positive match is determined between the record of the new user and the suspended-users profile data, the review process comprising:
i. confirming whether the positive match exists between the profile data of the record and the suspended-users profile data;
ii. allowing the new user to access the computer system, where the positive match is not confirmed; and
iii. denying the new user access to the computer system, and forwarding the profile data from the new-user record to the production suspended-users database, where the positive match is confirmed.

14. The method of claim 13, wherein the step of receiving a plurality of new-user records into a production new-user database further comprises creating an account for each new user.

15. The method of claim 13, wherein the step of updating the new-users profile database further comprises importing the production new-users database into the new-users profile database.

16. The method of claim 13, wherein the step of updating the suspended-users profile database further comprises importing the production suspended-users database into the suspended-users profile database.

17. The method of claim 13, further comprising the step of formulating the new-user profile data into at least one search command, after the step of updating the new-users profile database and before the step of similarity searching.

18. The method of claim 13, wherein the step of determining a positive or negative match further comprises
assigning a match score to each similarity search result set; and
comparing the match score to a pre-determined match tolerance level.

19. The method of claim 13, wherein a similarity search result set is received for each new-user record searched.

20. The method of claim 13, wherein one similarity search result set is received for all new-user records searched.

21. The method of claim 13, wherein the positive response process further comprises relaying the new-user record to a user-review database, before the step of confirming at least one similarity.

22. The method of claim 21, further comprising the step of displaying the user-review database via a web-based interface, after the step of relaying the new-user record to a user-review database and before the step of confirming at least one similarity.

23. The method of claim 13, wherein the step of denying a new user access to the computer system comprises permanently denying the new user access to the computer system.

24. The method of claim 13, wherein the step of denying a new user access to the computer system comprises temporarily denying the new user access to the computer system for a pre-determined period.

25. A software program, embodied on computer-readable media, incorporating the method of claim 13.

26. A system for verifying identities of new users of a computer system, using batch similarity searching, comprising:
means for receiving records from a plurality of new users;
means for extracting new-user profile data from each record;
means for similarity searching the new-user profile data against suspended-users profile data;
means for receiving similarity search results sets;
means for determining whether a positive match or a negative match exists between the new-user profile data of each record and the suspended-users profile data;
means for allowing a new user to access the computer system, where a negative match exists; and
means for reviewing the record of a new user, where a positive match exists between the record and suspended-users profile data, comprising:
means for confirming whether the positive match exists between the record and suspended-users profile data;
means for allowing the new user to access the computer system, where the positive match is not confirmed; and
means for denying the new user access to the computer system, where the positive match is confirmed.
